(19) United States
(12) Patent Application Publication
(10) Pub. No.: US 2009/0176557 A1
(43) Pub. Date: Jul. 9, 2009

(54) LEADERBOARD EVENT NOTIFICATION

(75) Inventors: GARY HALL, Redmond, WA (US); DEBRA THIEL, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, REDMOND, WA (US)

(21) Appl. No.: 11/971,764

(22) Filed: Jan. 9, 2008

(51) Int. Cl. G06F 17/00

(52) U.S. Cl. 463/25; 463/43

(57) ABSTRACT

A system and methods for notifying a subscriber of a gaming event. For example, a Leaderboard Alert Service receives notification from a messenger service that a subscriber is present on a messenger client device. The Service then identifies one or more players associated with the subscriber and begins to monitor a leaderboard database for scores achieved by players and scores achieved by the subscriber. The Service generates an event notification based on a comparison of the scores achieved by the one or more players with the score achieved by the subscriber. Upon generating an event notification, the Service sends the event notification to the messenger service.

### BACKGROUND

Today, video game players who enjoy games within a circle of friends have no automated way to know how their friends are doing at certain games. Some conventional multimedia consoles include features that allow players to see what their friends are playing. The players can only see what their friends are playing while each player is actively playing a games on their console. These multimedia consoles typically allow a player to view what games their friends are playing, but the player cannot view their friends' scoring. Competitive-minded players that want to know if one of their friends beats their high score for a particular game must repeatedly check the game leaderboards. Thus, a player cannot determine whether a friend passes them on a leaderboard until the player takes the time to visit the website.

### SUMMARY

One aspect of the present technology is to provide a method for notifying a subscriber of an event. In one embodiment, the user logs into a device that receives alerts. A Leaderboard Alert Service receives notification from a messenger service that the subscriber is present on the messenger client device. The Leaderboard Alert Service then identifies one or more users associated with the subscriber, and begins to monitor a leaderboard database for scores achieved by the one or more users and scores achieved by the subscriber. After obtaining these scores, the Leaderboard Alert Service compares each score achieved by the one or more users with the score achieved by the subscriber. If any of the player scores is ranked higher than the subscriber score, the Leaderboard Alert Service generates an event notification and sends the event notification to the messenger service.

Another aspect of the present technology is to provide a system that notifies a subscriber if a friend of the subscriber passes them on a leaderboard. In one embodiment, the system monitors a leaderboard database associated with an Xbox gaming environment by polling a leaderboard database for leaderboards containing a score associated with the subscribers gamertag. For each leaderboard containing a score associated with the subscribers gamertag, the system obtains each score associated with a players gamertag. In another embodiment, the system polls a leaderboard database associated with a Windows Live gaming environment and obtains scores associated with each of the subscriber's buddies. If any of the scores associated with a player gamertag or a buddy is ranked higher than the subscriber score, the system generates a game alert and sends the game alert to a messenger service. The messenger service forwards the game alert to the device the subscriber is logged into.

Yet another aspect of the present invention is to provide a system that may identify players associated with a subscriber, regardless of the gaming platform, so that the system may notify the subscriber of achievement accomplished by the players. In one embodiment, the system polls a leaderboard database that stores gaming information from several different platforms. For example, the leaderboard database may store game scores associated with games played on an Xbox, games played on a personal computer, games played on the Internet, games played on Messanger, and the like. By polling a single leaderboard database, the system may notify a subscriber when any player associated with the subscriber (e.g., Friends, Buddies, etc.) achieves a higher score, achieves a higher leaderboard position, and so on.

### BRIEF DESCRIPTION OF THE DRAWINGS

FIG. 1 depicts a schematic diagram illustrating one embodiment of a gaming environment;

FIG. 2 depicts a flow diagram illustrating exemplary steps for providing an event notification to a subscriber notifying the subscriber that an event has occurred;

FIG. 3 depicts a flow diagram illustrating exemplary steps for monitoring a leaderboard database;

FIG. 4 depicts a flow diagram illustrating exemplary steps for generating an event notification;

FIG. 5 depicts a flow diagram illustrating exemplary steps of another embodiment for generating an event notification;

FIG. 6 depicts and exemplary screen shot of an event notification;

FIG. 7 depicts another exemplary screen shot of an event notification; and

FIG. 8 depicts a schematic diagram of an exemplary computer system for generating an event notification.

### DETAILED DESCRIPTION

The technology described herein provides a system for generating a game alert notifying a user when another player has achieved a higher score for a particular game. In one embodiment, the system leverages the alerts system in LIVE MESSENGER to notify a subscriber of gaming events achieved by players within the subscriber's circle of friends. For example, suppose the subscriber is working at their office on a personal computer and a friend is playing “Doom” at home on their Xbox. And suppose the friend achieves a higher score than the subscriber's best score. When the friends' score is posted on a “Doom” leaderboard, the system will generate a game alert notifying the subscriber that the friend just beat their high score.

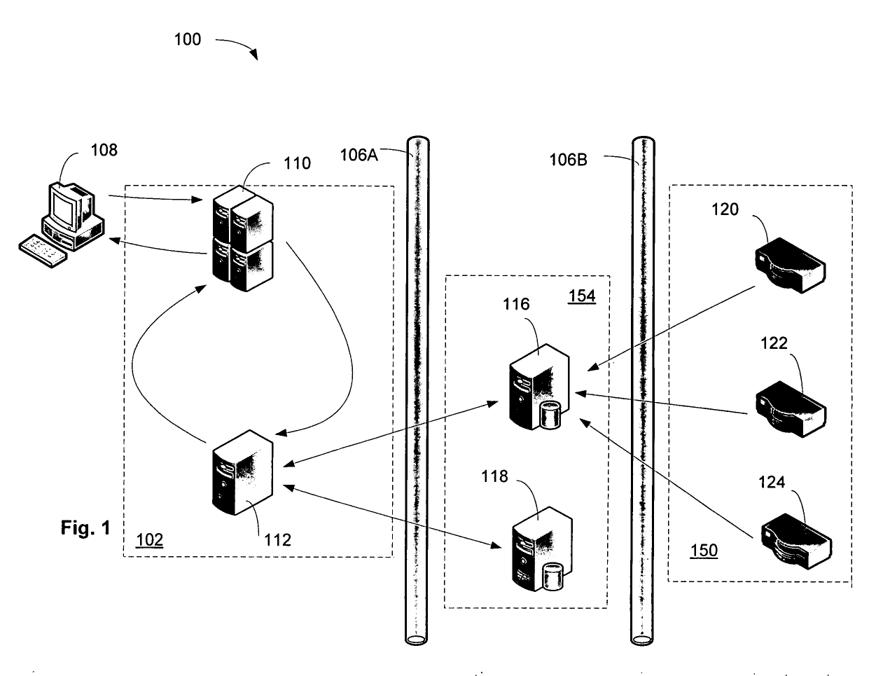

FIG. 1 is a block diagram of an exemplary online network multimedia (e.g., gaming) environment 100. FIG. 1 illustrates that the multimedia environment 100 includes a first public network 102, a second public network 150 and a data center 154. Each of the public networks is separated from the data center 154 by a security gateway 106. The first public network 102 is separated from the data center 154 by the security gateway 106A. The second public network 150 is separated from the data center 154 by a second security gateway 106B. The first public network 102 includes a messenger service 110 and a Leaderboard Alert Service 112. The second public network 150 includes a first multimedia console 120, a second multimedia console 122 and a third multimedia console 124. The data center 154 includes a leaderboard database 116 and a profile database 118.

The first multiple multimedia console 120, second multimedia console 122 and third multimedia console 124 each communicate with the data center 154 through the security gateway 106B. When implemented in a local area network (LAN) networking environment, multimedia consoles 120, 122 and 124 may be connected to a LAN via network interface. When implemented on a wide area network (WAN) networking environment, multimedia consoles 120, 122 and 124 may include a modem or other means for establishing communications over the WAN. The described network connections are illustrated only in other means of establishing communication links between the multimedia consoles 120, 122 and 124 may be implemented.

Security gateway 106B operates as a gateway between the second public network 150 and the data center 154. Security gateway 106B may be a cluster of one or more security gateway computing devices. The security gateway computing devices may collectively implement security gateway 106B. The data center 154 operates as a secure zone. Data center 154 is made up of trusted devices communicating via trusted communications. The private nature of the data center 154 refers to the restricted accessibility of the data center 154—access to the data center 154 is restricted to only certain individuals.

Within data center 154 is a leaderboard database 116 and a profile database 118. The leaderboard database 116 contains multiple leaderboards. Each leaderboard is dedicated to a single game. For example, the leaderboard database 116 may contain a leaderboard associated with each game provided through the Xbox Live entertainment system (e.g., “Doom,” “Halo 3,” etc.). In the Xbox Live embodiment, each console 120, 122 and 124 reports a game score to the leaderboard database 116 upon completion of the game. If the player's score is higher than the lowest score currently on the leaderboard, the player's username and score is posted on the leaderboard. For example, suppose the player playing Doom on console 120 has the gamertag DebbieDaGreat. When DebbieDaGreat finishes the game, if she has just achieved a new high score for her, her console 120 uploads her new high score to the leaderboard database 116. If DebbieDaGreat's new high score is higher than the lowest score on the Doom leaderboard in the leaderboard database 116, her score and gamertag are posted to the Doom leaderboard.

Current relationships on LIVE MESSENGER services and the Xbox Live entertainment system will be unified on the profile database 118. The profile database 118 collects and maintains usernames associated with players. A username refers to any screen name, handle, nickname, gamertag, buddy name and the like, used to identify a player for the purposes of accounting, security, logging and resource management. The profile database 118 also aggregates information supplied by other services, and fulfills real-time client requests for retrieving user profiles. In one embodiment, the profile database 118 stores a gamertag, buddy name, .NET Passport, and the like for every player that subscribes to the gaming environment 100. Any other information or username may be stored in the profile database 118.

Multimedia consoles 120, 122 and 124 are situated remotely from data center 154. A multimedia console 120 designed to communicate with the leader board database 116 and the data center 154 establishes a secure communication channel between the console 120 and the security gateway 106B. Multimedia console 120 and security gateway 106B encrypt/decrypt and authenticate data packets being passed back and forth, thereby allowing the data packets to be securely transmitted between them without being understood by other devices and they capture or copy the data packets without breaking the encryption. Each data packet communicated from multimedia console 120 to security gateway 106B, or from security gateway 106B2 multimedia console 120 can have data embedded therein.

FIG. 1 illustrates that the Leaderboard Alert Service (LAS) 112 communicates with the leaderboard database 166 and profile database 188 through the security gateway 106A. Security gateway 106A operates as a gateway between public network 102 and data center 154. Security gateway 106A may be a cluster of one or more security gateway computing devices. The security gateway computing devices may collectively implement security gateway 106A.

The LAS 112 also communicates to devices within the public network 102, such as the messenger service 1 10. The client device 108 shown in FIG. 1 comprises a personal computer. However, the client device 108 may comprise any device that can consume alerts such as, by way of example only, a mobile phone, a personal digital assistant, an the like. The messenger service 110 comprises a network-based system notification service for other devices.

The user logged into the device 108 is referred to, for purposes only of describing the technology herein, as a subscriber. A subscription is a request for specific information such as, by way of example only, scores achieved by friends or buddies associated with the subscriber. The subscription also includes information about the destination where alerts or notifications are sent. For explanatory purposes only, the exemplary embodiments of generating a game alert or event notification described herein are described with reference to video games. However, a subscriber may be notified of any event.

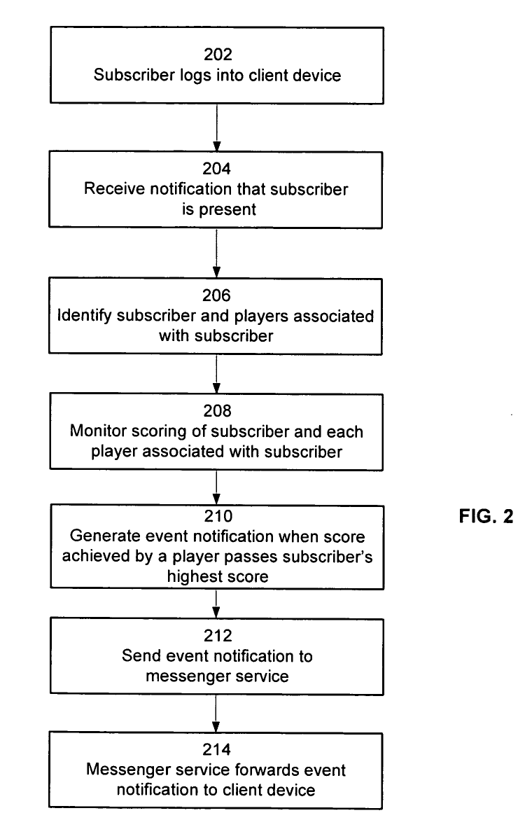

FIG. 2 illustrates exemplary steps for notifying a subscriber of a game event. In step 202, the subscriber logs into the client device 108. Suppose the subscriber logs into his personal computer at work, which has WINDOWS LIVE online services. The subscriber would proceed to log into LIVE MESSENGER by typing in his hotmail email address and password (the subscribers email address and password, combined, are also referred to as the subscriber's “messenger identification”). In this embodiment, the subscriber will receive alerts through LIVE MESSENGER. In an alternative embodiment, the subscriber receives alerts via other messenger services. In this alternative embodiment, the subscriber logs into the messenger service by entering the service-specific identification. Upon logging into the messenger client device 108, the subscriber's identification (e.g., hotmail address and password) is sent to the messenger service 110.

In step 204, the LAS 112 receives notification from the messenger service 110 that the subscriber has logged into the messenger client device 108. In the LIVE MESSENGER embodiment, the LAS receives the subscriber's e-mail address and password from the messenger service 110.

In step 206, the LAS 112 identifies the usernames associated with the subscriber and the usernames of players associated with the subscriber. Using the LIVE MESSENGER example above, the LAS 112 communicates with the profile database 118 via the network 142. The LAS 112 provides the subscriber's LIVE MESSENGER identification (ID) to the profile database 118.

The profile database 118, as discussed above, maintains a global list of usernames (e.g., players LIVE MESSENGER ID, gamertag, buddy name, etc.) associated with players. In one embodiment, the profile database 118 is populated with usernames entered by the players themselves. For example, in an XBOX game system, a player, through their console, may add or remove other players to their Friends List by adding a player's gamertag. There are several ways to add a player to a friends list.

To add a player to your LIVE MESSENGER contact list while playing a game, click Player Info while playing the game. Then, click the icon of the player you want to add to your Friends list. The Player Info drop down menu will appear. Click Add to my Friends list. The player will then receive a message with the option to accept or decline this request. If the player accepts your request, the player will also receive a message in LIVE MESSENGER to allow you to add that player to your Friends list. Once a player confirms your invitation (to add that player to your Friends list), the player's status will appear as online.

A player can also directly add a player's email address to their Contact list in LIVE MESSENGER. Open LIVE MESSENGER by double-clicking the LIVE MESSENGER icon in the System Tray by the System Clock on the Task bar. On the Contacts menu, click Add a contact. Click “Create a new contact by entering their email address or sign-in name.” Click Next. Click Finish or click Next to add more friends to your contact list. Similarly, in an instant message system, a user may add or remove a person to their Buddy List by adding the person's buddy name or screen name. The profile database 118 is updated periodically to, among other things, add the newly added friend/buddy or remove a deleted friend/buddy.

The profile database 118, upon receiving the subscriber's LIVE MESSENGER ID, identifies the usernames associated with the subscriber. For example, the profile database 118 will identify the subscriber's gamertag and buddy name. Once the usernames associated with the subscriber are identified, the profile database 118 identifies the usernames affiliated with players that are associated with the subscriber. For example, the profile database 118 will identify players gamertags for all players within the subscriber's friends' circle (based on the subscriber's gamertag). Similarly, the profile database 118, using the subscriber's buddy name, will identify buddy names of all players that are in the subscriber's buddy list. If other usernames are stored in the profile database 118, the profile database 118 will identify these usernames as well.

The profile database 118 passes the usernames associated with the subscriber (e.g., subscriber's gamertag, buddy name, etc.) and usernames associated with related players (e.g., gamertags of players within the subscriber's Friends List, buddy names of players within the subscriber's Buddy List, etc.) to the LAS 112. In one embodiment, the subscriber's usernames and player usernames are stored in the LAS 112. The LAS 112 requests the subscriber usernames and player usernames from the profile database 118 each time the subscriber logs into the device 108 to identify any usernames that were added to the profile database 118 since the subscriber last logged into the client device 108.

In step 208, the LAS 112 monitors the scoring of the subscriber and each player associated with the subscriber (e.g., a friend or buddy of the subscriber). As shown in FIG. 1, the LAS 112 communicates with the leaderboard database 116 via network 142. In one embodiment, the LAS 112 monitors the scoring of each player associated with the subscriber only while the subscriber is logged into the messenger client device 108. In this embodiment, the LAS 112 does not monitor the scoring of each player associated with the subscriber after the subscriber logs off the messenger client device 108. In an alternative embodiment, the LAS 112 monitors the scoring of each player associated with the subscriber regardless of whether the subscriber is logged into the messenger client 108 or is offline. In one embodiment, the LAS 112 monitors the actual scores associated with each player username listed in each leaderboard. In an alternative embodiment, the LAS 112 monitors the leaderboard position associated with each of the player usernames. Additional details of how the LAS 112 monitors the scores and leaderboard positions are provided hereinafter.

In step 210, the LAS 112 generates an event notification (also referred to as a “game alert”) if certain criteria are met. In one embodiment, the LAS 112 generates an event notification if the LAS 112 identifies a score associated with a player username that is ranked higher within the same leaderboard than the score associated with the subscriber's username. In an alternative embodiment, the LAS 112 generates an alert if a leaderboard position associated with a player username is higher within the same leaderboard than the subscriber's leaderboard position.

In step 212, the LAS 112 sends the event notification to the messenger service 1 10. In step 214, the messenger service 110 sends the event notification to the messenger client device 108. In the example whereby the subscriber is working at the office on his personal computer, the personal computer comprises the client device 108. If the subscriber has designated his personal computer as the device to receive alerts, the subscriber receives the alert on his personal computer 108. The term “client device” is not limited to personal computers and may include, by way of example only, any device that can consume alerts such as a cellular phone, a personal digital assistant, and the like.

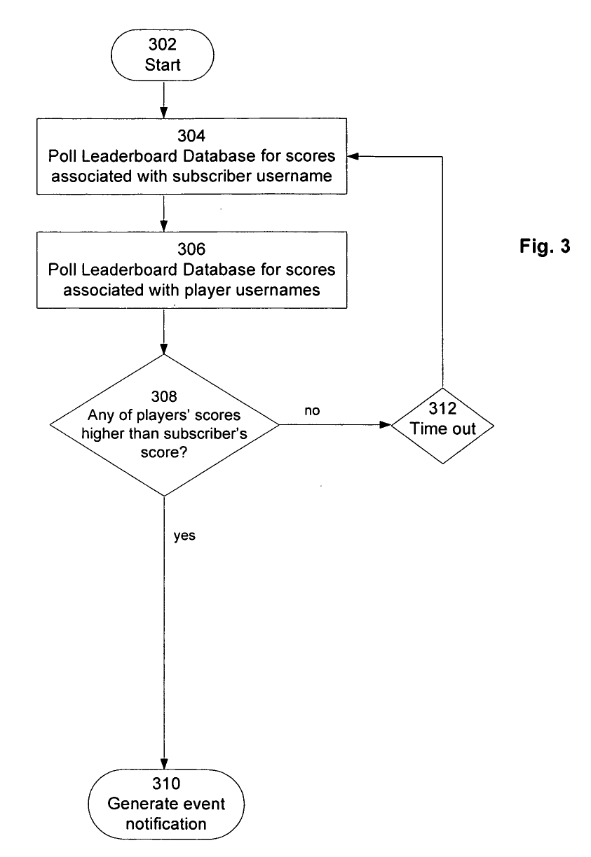

FIG. 3 illustrates exemplary steps of monitoring the scoring of each player associated with the subscriber (e.g., a friend of the subscriber, a buddy of the subscriber, etc.). Prior to step 302, the LAS 112 has already identified the subscriber's usernames and the usernames of players associated with the subscriber. In step 302, the LAS 112 begins the monitoring process.

In step 304, the LAS 112 polls the leaderboard database 116 for scores associated with a subscriber username posted on any leaderboard. Thus, if the subscriber has, for example, a gamertag and buddy name, the LAS 112 will poll the leaderboard database 116 for leaderboards containing the subscriber's gamertag and buddy name. Then, for each such leaderboard, the LAS 112 polls the leaderboard database 116 for scores associated with each player username. For example, if the LAS 112 identified the subscriber's gamertag on a “Doom” leaderboard, the LAS 112 will poll the leaderboard database 116 for player gamertags within the subscriber's circle of friends. In one embodiment, the LAS 112 retrieves each score associated with the subscriber's username on each leaderboard and each score associated with a player username from the leaderboard database 116 and stores this information. In an alternative embodiment, the LAS 112 retrieves the leaderboard positions associated the subscriber's username and each player username contained in the leaderboard database 116 for these scores.

In step 308, the LAS112 compares, by leaderboard, each of the scores associated with a player username with the score associated with the subscriber username. The LAS 112 determines if any of the scores associated with a player username is ranked higher than the score associated with the subscriber username. If any of the scores associated with a player username is ranked higher than the score associated with the subscriber username, the LAS 112 will proceed to generate an event notification, in step 310. In the “Doom” leaderboard example, the LAS 112 compares the score associated with the subscriber's gamertag with each of the scores associated with a player gamertag. If any of the scores associated with a player gamertag are ranked higher than the subscriber's score, the LAS 112 generates an event notification or game alert.

If, however, none of the scores on the “Doom” leaderboard associated with a player gamertag are higher than the score associated with the subscriber gamertag, the LAS 112 will time out, in step 312. LAS 112 may time out for any period of time. In one embodiment, the LAS 112 will time out for two minutes. In an alternative embodiment, the LAS 112 will time out for other amounts of time such as, by way of example, three minutes, five minutes, ten minutes, and the like.

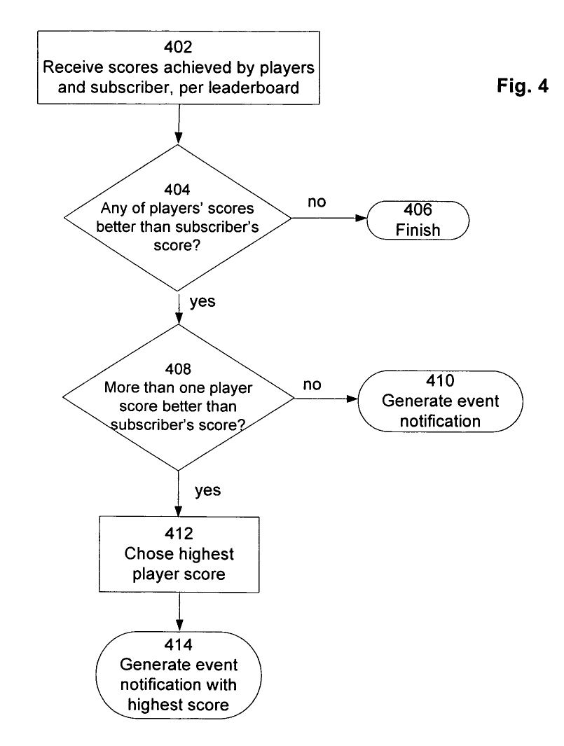

After the LAS 112 has finished timing out (step 312), the LAS 112 again polls the leaderboard database 116 for leaderboards containing scores associated with the subscriber username, by returning to step 304. In step 306, the LAS 112 polls each of the leaderboards containing a score associated with the subscriber username for scores associated with a player username. In step 308, the LAS 112 compares each of the scores associated with a player username with the score associated with the subscriber username, for each leaderboard. The LAS 112 determines if any of the scores associated with the player username is ranked higher than a score associated with the subscriber username. If none of the scores associated with a player username are ranked higher than the score associated with the subscriber username, then a LAS 112 again times itself out (returns to step 312 in FIG. 4). By timing out periodically, the LAS 112 continuously monitors the leaderboard database 116 for the most recent high scores associated with player usernames. Thus, the subscriber does not have to log onto a leaderboard website to see if a friend or buddy has beat his high score for a particular game. If the LAS 112 determines that a score associated with a player username is ranked higher than a score associated with the subscriber username, in step 308, the LAS 112 generates an event notification (step 310 in FIG. 4).

FIG. 4 illustrates a flow diagram providing exemplary steps for generating an event notification (step 210 in FIG. 2). In this embodiment, if the LAS 112 identifies more than one score associated with a player username that is ranked higher than the score associated with the subscriber's username, the LAS 112 generates an event notification related to only the highest score associated with a player username.

In step 402, suppose the LAS 112 receives multiple scores associated with a player username and a score associated with the subscriber username from a particular leader board. For example, suppose that the LAS 112 polls the leaderboard database 116 and, for the “Halo 3” leaderboard, identifies the subscriber's gamertag “BigDogT.” The LAS 112 then identifies the following three player gamertags that are within BigDogT's circle of friends: DebbieDaGreat, GaryDaGreat and OnTheRun. The LAS 112 obtains the score associated with BigDogT (800) and the three scores associated with DebbieDaGreat (875), GaryDaGreat (860) and OnTheRun (855).

In step 404, the LAS 112 determines if the score associated DebbieDaGreat, GaryDaGreat or OnTheeRun is ranked higher than the score associated with BigDogT. If none of the scores associated with DebbieDaGreat, GaryDaGreat or OnTheeRun were ranked higher than the score associated with BigDogT, the LAS 112 does not generate an event notification (step 406).

Here, however, all three scores associated with DebbieDaGreat, GaryDaGreat and OnTheeRun are ranked higher than the score associated with BigDogT. DebbieDaGreat's score of 875 is ranked higher than BigDogT's score off 800. GaryDaGreat's score of 860 is ranked higher than BigDogT's score off 800. OnTheRun's score of 855 is ranked higher than BigDogT's score off 800. Thus, the LAS 112 determines that at least one of the scores associated with a player gamertag is ranked higher than the score associated with the subscriber gamertag (step 404), and proceeds to step 408. In step 408, the LAS 112 determines if more than one of the three scores associated with DebbieDaGreat, GaryDaGreat and OnTheRun is ranked higher than the score achieved by BigDogT. Here, all three scores are higher. Thus, the LAS 112 determines that more than one of the scores is ranked higher than the score associated with BigDogT. The LAS 112 chooses the highest score associated with a player gamertag, the score of 875 achieved by DebbieDaGreat, in step 412. The LAS 112 then generates a single event notification related to only the gamertag DebbieDaGreat and her score of 875.

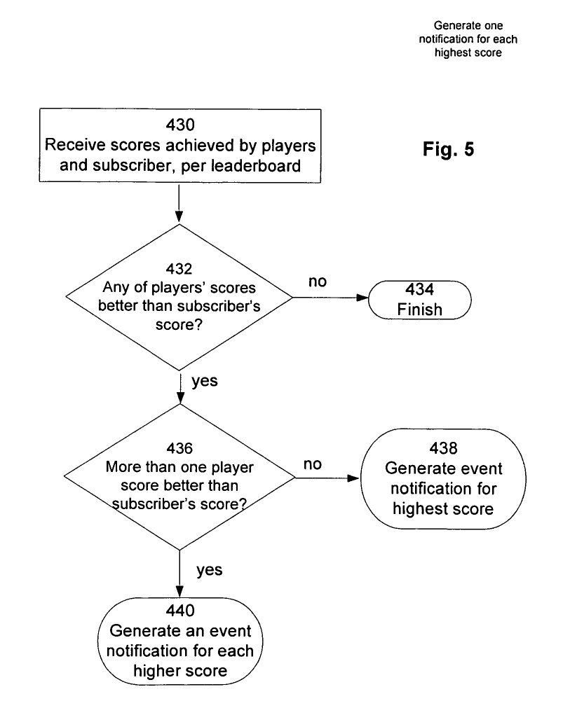

FIG. 5 illustrates a flow diagram providing exemplary steps whereby the LAS 112 generates an event notification for each of the scores associated with the player gamertag that is ranked higher than the score associated with the subscriber gamertag. Using the same “Halo 3” leaderboard example above, in step 430, the LAS 112 receives the three gamertags DebbieDaGreat, GaryDaGreat and OnTheRun, and the score associated with each gamertag, 875, 860 and 955 respectively. In step 432, the LAS 112 compares each of the three scores associated with DebbieDaGreat, GaryDaGreat and OnTheRun from the “Halo 3” leaderboard with the “Halo 3” score achieved by BigDogT (800). Here, the LAS 112, in step 432, determines that at least one of the three scores associated with DebbieDaGreat, GaryDaGreat and OnTheRun is ranked higher than the score achieved by BigDogT.

In step 436, the LAS 112 determines if more than one of the three scores is ranked higher than the score associated with BigDogT for that particular leader board. The LAS 112 determines, in step 436, that all three scores achieved by DebbieDaGreat, GaryDaGreat and OnTheRun are ranked higher than the score associated with BigDogT. Thus, the LAS 112 proceeds to generate three event notifications, one for each of the scores associated with a player gamertag, in step 440. For example, the LAS 112 will generate one event notification related to DebbieDaGreat's score of 875, a second event notification related to GaryDaGreat's score of 860, and a third event notification related to OnTheRun's score of 855. If, for example, BigDogT were logged into her computer (client device 108) at work, BigDogT would receive three separate alerts notifying her that three of her friends beat her high score in “Doom.” If BigDogT cannot stand it when any of her friends beat her high score in “Doom,” she may want to take a break right then (upon receiving the alerts), play “Doom” and attempt to reclaim her high score.

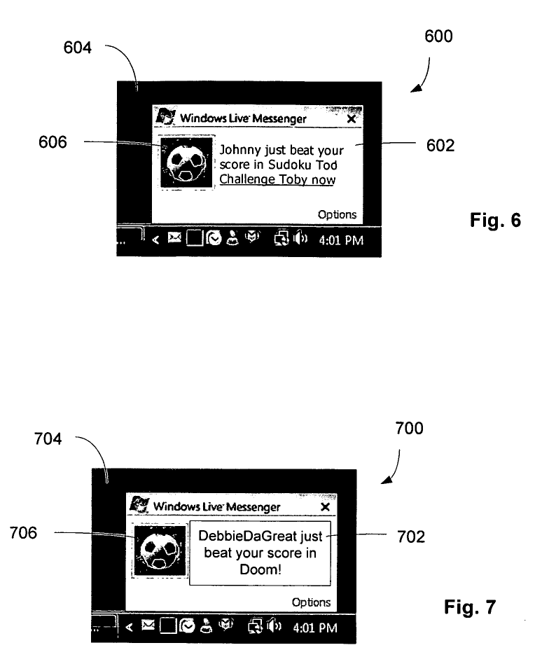

FIGS. 6-7 illustrate exemplary event notifications (also referred to as “game alerts”). FIG. 6 illustrates an exemplary event notification 600. The event notification 600 shown in FIG. 6 was generated because a player associated with the subscriber beat the subscriber's best score playing a Sudoku puzzle. In this embodiment, the event notification 600 comprises a pop-up alert window 602 displayed on a computer screen 604. The window 602 contains the message “Johnny just beat your score in Sudoku Too!” and an icon 606. In the example provided above where the subscriber, BigDogT, is working on her computer at work, BigDogT receives the pop-up window 602 on her computer screen 604. At this point, BigDogT may decide to take a break right then, and play a Sudoku puzzle and reclaim her high score.

FIG. 7 illustrates an event notification 700. The event notification 700 shown in FIG. 7 is an example of an event notification that may be generated because DebbieDaGreat, GaryDaGreat and OnTheRun achieved a higher score in “Doom” that BigDogT. In this embodiment, the event notification 700 comprises a pop-up alert window 702 displayed on a computer screen 704. The window 702 contains the message “DebbieDaGreat just beat your score in Doom!” and an icon 706. In one embodiment, the icon 706 is DebbieDaGreat's avatar, if she has one. In the example provided above where the subscriber, BigDogT, is working on her computer at work, BigDogT receives the pop-up window 702 on her computer screen 704. At this point, BigDogT may decide to take a break right then, and play Doom and reclaim her high score.

The event notifications shown in FIGS. 6-7 illustrate exemplary notifications to a subscriber logged into a personal computer having LIVE MESSENGER services. However, an event notification may comprise any format and may be specific to the gaming environment (e.g., XBOX LIVE, LIVE MESSENGER, AIM, etc.).

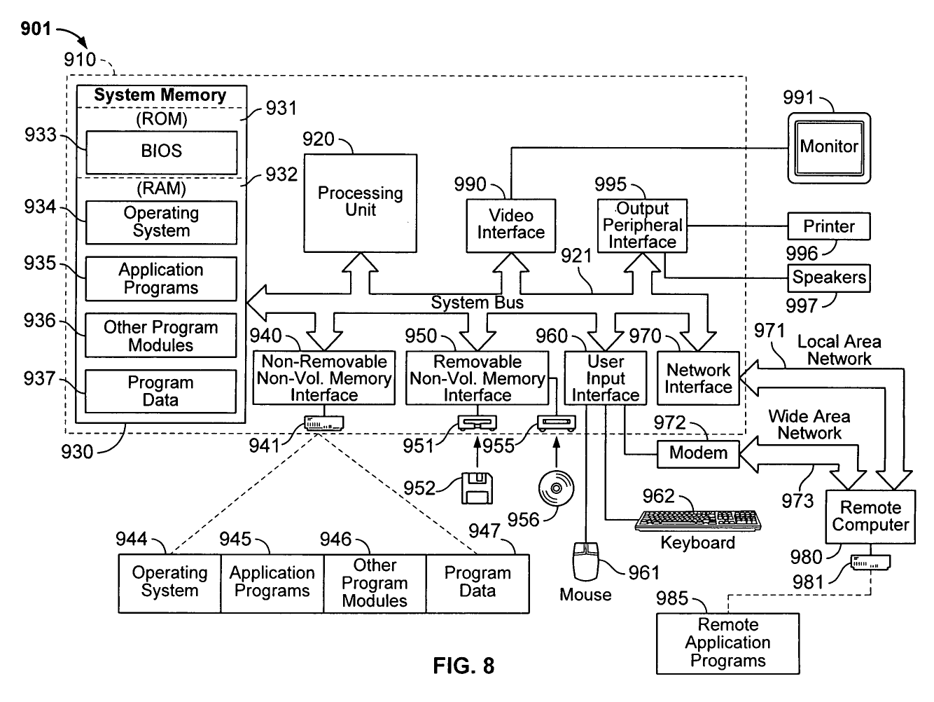

FIG. 8 illustrates an example of a suitable general computing system environment 901 for monitoring a leaderboard database and generating event notifications as described above. It is understood that the term “computer” as used herein broadly applies to any digital or computing device or system. The computing system environment 901 is only one example of a suitable computing environment and is not intended to suggest any limitation as to the scope of use or functionality of the inventive system. Neither should the computing system environment 901 be interpreted as having any dependency or requirement relating to any one or combination of components illustrated in the exemplary computing system environment 901.

With reference to FIG. 8, an exemplary system for implementing the inventive system includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 may include a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 910. Communication media typically embodies computer readable instructions, data structures, program modules or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as radio frequency and other wireless media. Combinations of any of the above are also included within the scope of computer readable media.

The system memory 930 includes computer storage media in the form of volatile and/or nonvolatile memory such as ROM 931 and RAM 932. A basic input/output system (BIOS) 933, containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 8 illustrates operating system 934, application programs 935, other program modules 936, and program data 937.

The computer 910 may also include other removable/non-removable, volatile/nonvolatile computer storage media. By way of example only, FIG. 8 illustrates a hard disc drive 941 that reads from or writes to non-removable, nonvolatile magnetic media and a magnetic disc drive 951 that reads from or writes to a removable, nonvolatile magnetic disc 952. Computer 910 may further include an optical media reading device 955 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 941 is typically connected to the system bus 921 through a non-removable memory interface such as interface 940. Magnetic disc drive 951 and optical media reading device 955 are typically connected to the system bus 921 by a removable memory interface, such as interface 950.

The drives and their associated computer storage media discussed above and illustrated in FIG. 8, provide storage of computer readable instructions, data structures, program modules and other data for the computer 910. In FIG. 8, for example, hard disc drive 941 is illustrated as storing operating system 944, application programs 945, other program modules 946, and program data 947. These components can either be the same as or different from operating system 934, application programs 935, other program modules 936, and program data 937. Operating system 944, application programs 945, other program modules 946, and program data 947 are given different numbers here to illustrate that, at a minimum, they are different copies.

A user may enter commands and information into the computer 910 through input devices such as a keyboard 962 and a pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus 921, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 8. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communication over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 8 illustrates remote application programs 985 as residing on memory device 981. It will be appreciated that the network connections shown are exemplary and other means of establishing a communication link between the computers may be used.

The subject matter of the present technology is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. In addition, it is assumed that one skilled in the art is familiar with details pertaining to television signal detection, and so such details are omitted herein for purposes of clarity.

While the present technology has been described in connection with the embodiments of the various figures, it is to be understood that other similar embodiments may be used or modifications and additions may be made to the described embodiment for performing the same function of the present technology without deviating therefrom. Therefore, the present technology should not be limited to any single embodiment, but rather should be construed in breadth and scope in accordance with the appended claims.

We claim:

1. A method for notifying a subscriber of an event, comprising:
receiving notification from a messenger service that a subscriber is present on a messenger client device;
identifying one or more users associated with the subscriber;
monitoring a leaderboard database for scores achieved by the one or more users and scores achieved by the subscriber, wherein the leaderboard database contains multiple leaderboards each having one leaderboard associated with a game played on a console;
comparing each score achieved by the one or more users with the score achieved by the subscriber; and
generating an event notification based on comparing the scores achieved by the one or more users with the score achieved by the subscriber.

2. The method as recited in claim 1, further comprising:
sending the event notification to the messenger service.

3. The method as recited in claim 2, wherein identifying one or more users associated with the subscriber comprises:
providing the subscriber identification received from the messenger service to a player database;
receiving, from the player database, a username affiliated with each of the one or more users and a username affiliated with the subscriber.

4. The method as recited in claim 3, wherein monitoring a leaderboard database comprises:
querying a leaderboard database for leaderboards containing a score associated with the username affiliated with the subscriber;
for each leaderboard that contains a score associated with the username affiliated with the subscriber, querying the leaderboard for scores associated with usernames affiliated with the one or more users; and
in response to the queries, receiving the scores associated with the username affiliated with the subscriber and scores associated with the usernames affiliated with the one or more users.

5. The method as recited in claim 3, wherein monitoring a leaderboard database comprises:
querying a leaderboard database for leaderboards containing a leaderboard position associated with the username affiliated with the subscriber;
for each leaderboard containing a leaderboard position associated with the username affiliated with the subscriber, querying the leaderboard for leaderboard positions associated with usernames affiliated with the one or more users; and
in response to the queries, receiving the leaderboard positions associated with the username affiliated with the subscriber and the leaderboard positions associated with the usernames affiliated with the one or more users.

6. The method as recited in claim 4, wherein comparing the score achieved by the one or more users with the score achieved by the subscriber comprises:
organizing the scores associated with the usernames affiliated with the one or more users and the scores associated with the username affiliated with the subscriber per leaderboard; and
for each leaderboard, determining whether any of the scores associated with the usernames affiliated with the one or more users ranks higher than the score associated with the username affiliated with the subscriber.

7. The method as recited in claim 6, wherein generating an event notification comprises:
if it is determined that a score associated with a username affiliated with the one or more users ranks higher than the score associated with the username affiliated with the subscriber, generating an event notification containing the username affiliated with the one or more users associated with the higher ranked score.

8. The method as recited in claim 6, wherein generating an event notification comprises:
if it is determined that more than one score associated with a username affiliated with the one or more users ranks higher than the score associated with the username affiliated with the subscriber, generating an event notification containing only the username affiliated with the one or more users associated with the highest ranked score.

9. A method for notifying a subscriber logged into a messenger client device that a player associated with the subscriber achieved a higher score than the subscriber in connection with a game played on a console, comprising:
receiving notification from a messenger service that the subscriber is present on the messenger client device, wherein the notification includes the subscriber's messenger identification;
obtaining a username affiliated with the subscriber and at least one username affiliated with a player associated with the subscriber from a player database, wherein the player database contains usernames affiliated with the subscriber and usernames affiliated with at least one player based on the subscriber's messenger identification;
polling a leaderboard database for a score associated with one of the subscriber's usernames and a score associated with at least one player username, wherein the score associated with the at least one player is posted to the leaderboard database by a console; and
generating an event notification if a score associated with at least one player username is better than the score associated with the subscriber's username.

10. The method as recited in claim 9, wherein polling a leaderboard database comprises:
identifying each leaderboard that contains one of the subscriber's usernames;
for each leaderboard that contains a subscriber username,
retrieving the score associated with the subscriber's username; and
retrieving each score associated with a player username.

11. The method as recited in claim 10, wherein generating an event notification comprises:
organizing the retrieved scores associated with each player username and the retrieved scores associated with the subscriber's username per leaderboard;
for each organized leaderboard, determining whether any of the scores associated with a player username ranks higher than the score associated with the subscriber's username; and
generating an event notification if one of the scores associated with a player username ranks higher than the score associated with the subscriber's username.

12. The method as recited in claim 11, wherein generating an event notification comprises:
if more than one score associated with a player username ranks higher then the score associated with the subscriber's username, generating an event notification containing only the player username associated with the highest ranked score.

13. The method as recited in claim 11, wherein generating an event notification comprises:
if more than one score associated with a player username ranks higher then the score associated with the subscriber's username, generating an event notification for each player username for a higher ranked score.

14. One or more processor readable storage devices having processor readable code embodied on said processor readable storage devices, said processor readable code for programming one or more processors to perform a method for notifying a user logged into a messenger client device that a player associated with the user achieved a higher score than the user in a particular game that is played on a console, comprising:
obtaining the user's gamertag and one or more player gamertags from a profile database, wherein the profile database identifies the user gamertag and each of the one or more player gamertags based on a messenger identification provided by the user;
polling a leaderboard database for a score associated with the user's gamertag;
for each leaderboard containing a score associated with the user's gamertag, retrieving the score associated with the user's gamertag and each score associated with a player gamertag;
comparing each score associated with a player gamertag with the score associated with the user gamertag;
generating an event notification based on comparing each score associated with a player gamertag with the score associated with the user gamertag;

15. The one or more processor readable storage devices as recited in claim 14, wherein retrieving the score associated with the user gamertag and each score associated with a player gamertag comprises:
querying the leaderboard database for each score on the leaderboard associated with a player gamertag;
querying the leaderboard database for a score on the leaderboard associated with the user gamertag;
storing each score on a leaderboard associated with a player gamertag and the score on the leaderboard associated with the user gamertag; and
organizing each score on a leaderboard associated with a player gamertag and the score on the leaderboard associated with the user gamertag by leaderboard.

16. The one or more processor readable storage devices as recited in claim 14, wherein comparing each score associated with a player gamertag with the score associated with the user gamertag comprises:
comparing the score posted on a leaderboard associated with each player gamertag with the score posted on the leaderboard associated with the user gamertag; and
determining whether each of the scores on the leaderboard associated with a player gamertag is ranked higher than the score on the leaderboard associated with the user gamertag.

17. The one or more processor readable storage devices as recited in claim 16, wherein generating a game alert comprises:
generating an event notification if it is determined that a score on the leaderboard associated with a player gamertag is ranked higher than the score on the leaderboard associated with the user gamertag.

18. The one or more processor readable storage devices as recited in claim 14, wherein polling a leaderboard database for leaderboards containing a score associated with the user gamertag occurs at predetermined intervals.

19. The one or more processor readable storage devices as recited in claim 14, wherein each score on a leaderboard associated with a player gamertag was posted to the leaderboard database by a console.

20. The one or more processor readable storage devices as recited in claim 14, wherein comparing each score associated with a player gamertag with the score associated with the user gamertag comprises:
comparing the leaderboard position associated with each player gamertag with the leaderboard position associated with the user gamertag; and
determining whether each of the leaderboard positions associated with a player gamertag is ranked higher than the leaderboard position associated with the user gamertag.
